(19) United States
(12) Patent Application Publication
(10) Pub. No.: US 2013/0125449 A1
(43) Pub. Date: May 23, 2013

(54) Control of Dust Mites

(71) Applicant: Anthony E. Winston, East Brunswick, NJ (US)

(72) Inventor: Anthony E. Winston, East Brunswick, NJ (US)

(21) Appl. No.: 13/683,275

(22) Filed: Nov. 21, 2012

Related U.S. Application Data
(60) Provisional application No. 61/562,599, filed on Nov. 22, 2011.

(51) Int. Cl. A01M 13/00

(52) U.S. Cl. CPC A01M 13/003
USPC 43/125

(57) ABSTRACT

A method of eliminating, reducing or preventing unwanted pests such as dust mites, fleas, bed bugs, arachnids or insects from fabric articles, comprising contacting the fabric articles with carbon dioxide and/or ammonia gas generated from one or more salts, capable of generating carbon dioxide and/or ammonia gas such as by heat, moisture or reaction with an acid or a base.

### BACKGROUND OF THE INVENTION

Pests, such as bed bugs (Cimex lectularius), lice, tics, fleas, dust mites, arachnids, insects and others can be introduced into the home and other living areas, and be present in articles made from fabrics, including bedding, mattresses, pillows, cushions, carpeting, furniture, upholstery, drapes, etc. Eradicating these pests, especially bed bugs, can be extremely difficult, and can result in an on-going battle that can be physically, mentally, and financially taxing. Once limited mainly to third world locations, the bed bug problem has spread such that any country, indeed any hotel, may be a potential source of infestation. The problem has grown to sufficient size that the US Environmental Protection Agency (EPA) held a two day national Bed Bug Summit in Washington, D.C. in April of 2009.

### DESCRIPTION OF THE INVENTION

In this invention, an article to be decontaminated is confined in a container together with one or more salts capable of generating an effective quantity of carbon dioxide or ammonia due to heat or the presence of water. The container is sealed to prevent the loss of gas within the container and the salt or salts are treated to release carbon dioxide or ammonia gas into the atmosphere of the container by means of heat or the addition of moisture. The gas pervades the container and the articles therein for such a time as is needed for the trapped gas to kill any dust mites, arachnids, insects or any other undesirable pests within the articles being decontaminated. Subsequently, the trapped gas is allowed to escape safely from the treated articles and container into the atmosphere.

Alternatively, pests can be eliminated by the application of a woven or non-woven sheet with entrapped particles of one or more salts capable of generating carbon dioxide or ammonia gas onto and into the article being decontaminated with activation of the inorganic salts using moisture or heat. The sheet with entrapped particles may be placed in an enclosed container and activated as above described or the sheet can be placed onto, into, adjacent or juxtaposed to the contaminated article and activated to release the CO₂ or ammonia gas into the article. Sufficient gas can be introduced this way to prevent the growth of these pests or to reduce the pest population already present. More than one treatment may be needed for complete elimination.

The salt or combination of salts used in this invention are capable of releasing carbon dioxide or ammonia or both. A preferred salt is ammonium bicarbonate, which decomposes to carbon dioxide and ammonia gas upon heating. Other suitable salts, which readily release carbon dioxide and ammonia gas, are ammonium carbonate and ammonium carbamate.

The ammonia and carbon dioxide releasing salts, which can be employed in the process decompose at a slow rate at ambient temperatures such as 20° C. The rate of decomposition increases as the temperature increases. Thus the above mentioned salts could be applied without the addition of heat or moisture provided the contact time is extended. However, such treatment could take days or even weeks to be effective. Ammonium bicarbonate decomposes fairly rapidly at temperatures above about 36° C. and the rate increases as the temperature is further raised. Above about 60° C., the decomposition is very rapid. Therefore, for optimum release of ammonia and carbon dioxide, it would be preferred to heat to a temperature of at least 35° C. and up to about 60° C.

Other salts which can be used to generate ammonia include ammonium salts such as ammonium acetate, ammonium chloride, ammonium phosphate, ammonium sulfate, in combination with alkali or alkaline salts such as calcium oxide, sodium or potassium carbonate, trisodium or tripotassium phosphate. Also, sodium or potassium bicarbonate, can be either heat activated or acid activated to release carbon dioxide using for example citric acid, a magnesium salt, or sodium bisulfate. Baking soda slowly releases carbon dioxide when heated above about 45° C. Accordingly, it would be preferred to heat baking soda to above about 70° C. to deliver CO₂ on at a rapid speed. Ammonia gas is generally more effective than carbon dioxide in eliminating pests. Thus lower concentrations of ammonia are needed to kill the target pests. However, carbon dioxide can be effective if higher concentrations are used and may have the advantage of being less toxic or irritating to human beings.

In general, the invention is directed to the use of salts which can be dispersed within a confined space, or placed onto, adjacent to or juxtaposed to an article to be decontaminated. Using this method a wide range of pests can be eliminated with ammonia gas, carbon dioxide gas, or a combination of ammonia and carbon dioxide. Ammonia gas and carbon dioxide gas is generated by decomposing ammonium bicarbonate, ammonium carbonate, ammonium carbamate or an alkali bicarbonate with heat; carbon dioxide is generated by decomposing a bicarbonate or carbonate salt using an acid or acid salt; and ammonia is generated by reacting an ammonium salt with an alkali or alkaline salt.

A preferred method of applying the salts is to provide them in a porous container such as a sachet or box from which the ammonia gas can escape and pervade the articles being treated. Heat can be applied by any means. A particularly convenient method is to supply a separate sealed container, containing two compounds which react exothermically when mixed together. Before activation the reactive components are kept separate. An example of such a reactive combination is sodium carbonate and water. Water hydrates sodium carbonate forming sodium carbonate monohydrate, heptahydrate and decahydrate releasing much heat in the process. The heat producing container is placed immediately adjacent to the gas-releasing salt prior to activation.

The gas generating particulate salt which is employed in the invention process for fabric decontamination preferably has an average particle size between about 25 microns and 1000 microns. It should be understood that the particle size is not critical to the decomposition and gas generating process, but may have limitations regarding the ease of handling of such materials. Smaller particle sizes will be used when the salt or salts are coated or impregnated into a woven or non-woven sheet for placing adjacent a fabric article to be treated. Sizes of such particles preferably can range from about 20 to 200 microns.

The heat for reaction can be generated by any means, including an electrical heater, hot air, or by chemical reaction, e.g. hydrating an exothermic hydratable salt. When moisture is used to decompose the gas-generating salt, the addition of water can be attained from ambient moisture in the confined space, or the addition of water from outside the confined space. If moisture is damaging to the materials being treated it can be sequestered by providing a moisture scavenger salt, e.g. trisodium phosphate, sodium acetate, sodium carbonate, or dehydrating agents such as silica. The moisture scavenger can be mixed with the gas-producing salt or can be supplied in porous sachets. Decomposition of ammonium or other bicabonate salts using heat results in the generation of water. Therefore the presence of a moisture scavenger is often desirable to keep the fabrics being decontaminated dry.

If the decontamination process is conducted by placing the object to be decontaminated within a confined space, the confined space can be formed by any type of rigid or flexible container which preferably should be sealed, and which can confine the gas that is generated for a sufficient time to provide a lethal environment for the unwanted pests. The containers may be provided with one or more ports to initially remove air from the confined space, and/or to provide moisture or heat such as hot air within the confined space to activate the gas-generating salt. The gas-generating salts can simply be placed within the confined space as a solid, or can preferably be provided in one or more porous packages which can allow decomposition of the salt and the generation of the gas from the porous package and release into the confined space. To provide heat, the container may be placed on an electric heating pad or blanket, or the like. The gas-generating salt may also be present as a porous sheet containing the gas-generating salt, and the lethal environment for the pests provided by simply placing the porous sheet within the confined space, and activating with heat or moisture. If ammonium bicarbonate is used, heat may not be necessary to generate the gas. However, since the decomposition of ammonium bicarbonate is quite slow at room temperature it may take several days or weeks to decontaminate an article under these conditions.

Alternately, the sheet into which the gas-generating salt is dispersed may be placed in contact with the fabric to be decontaminated in the open environment. Addition of heat can be applied from an electric heat source, or even the human body. Thus, a layer of inner sheeting can be used to separate the body from direct contact with the salt to prevent undesirable skin irritation. The body would provide the necessary heat to provide activation or decomposing of the salts to provide the ammonia or carbon dioxide gas. While the gas in close proximity to the fabric would be provided in lethal doses to kill any pests, the concentrations would not be harmful to humans.

As noted, the generation of ammonia gas is more lethal to the pests than carbon dioxide. Hence, less salt is needed with an ammonia gas generated system than one used to generate carbon dioxide. It is believed that at least about 500 ppm of ammonia gas is required to rapidly kill the mites, fleas, bed bugs and other pests as described above. An oxygen-containing atmosphere containing at least around 5% carbon dioxide is required to kill the bugs and other pests. However, if oxygen is excluded from the atmosphere, or the concentration of oxygen is reduced, lower concentrations of carbon dioxide are effective. Desirably, the concentrations of ammonia and carbon dioxide gas adjacent the article to be decontaminated can be increased and relative concentration of oxygen lowered when using a confined container system by vacuuming out the air from the container, prior to releasing the gas. While a rigid container can be used in such process, commercial flexible plastic containers, such as polyethylene bags are available, which allow the much of the air contained within the container to be removed such as by an ordinary vacuum cleaner. This allows maximal ammonia or carbon dioxide gas concentrations and hence greatly increases efficacy.

Lethal gas concentrations and salt levels can be readily determined by those of ordinary skill in the art. Thus, one mole of gas has a volume of about 25 liters at room temperature. One mole of ammonia and one mole of carbon dioxide are released by 79 grams of ammonium bicarbonate when the ammonium bicarbonate is decomposed by heat. Water vapor is also produced in the process. This water vapor can be sequestered as described above by various moisture scavenger salts or dehydrating agents.

One half a mole of carbon dioxide is released when 84 grams of sodium bicarbonate decomposes due to heating. One mole of carbon dioxide is released when 84 grams of sodium bicaronate is reacted with an acid. Likewise, one mole of ammonia is released by one mole of a mono-ammonium salt, e.g. NH₄Cl, reacted with an alkali. Two moles of ammonia are released when one mole of a diammonium salt, e.g. (NH₄)₂SO₄ is reacted with an alkali. Accordingly, one skilled in the art will be able to readily determine how much salt is required to achieve the lethal gas concentration within the environment of the contaminated fabric being treated.

### EXAMPLES

### Decontamination Using Confined Container

NH₄HCO₃ Target concentration NH₃ 500-5000 ppm

| | | | | Preferred levels | | | |
|---|---|---|---|---|---|---|---|
| | | Range | | Without | | With | |
| | Air volume | NH₄HCO₃ | | Vacuum | | Vacuum | |
| Queen Size | 700 liters | 1 g-10 | g | 2-3 | g | 0.5-1 | g |
| Mattress | | | | | | | |
| King Size | 1400 liters | 2 g-20 | g | 4-6 | g | 1-2 | g |
| Regular Single | 250 liters | 0.4-4 | g | 0.8 g-1.2 | g | 0.2-0.5 | g |
| Pillow | 40 liters | 0.07-0.7 | g | 0.2-0.3 | g | 0.05-0.15 | g |

NaHCO₃ Target concentration CO₂ 5 −20%

| | | | Preferred levels | |
|---|---|---|---|---|
| | | Range | Without | With |
| | Air volume | NaHCO₃ | Vacuum | Vacuum |
| Queen Size Mattress | 700 liters | 100 g-400 g | 250 g | 25-100 g |
| King Size | 1400 liters | 200 g-800 g | 500 g | 10-200 g |
| Regular Single | 250 liters | 36 g-144 g | 100 g | 5-40 g |
| Pillow | 40 liters | 6 g-18 g | 16 g | 2-10 g |

### Decontamination Using Sheet

| | Range | |
|---|---|---|
| | NH₄HCO₃ | |
| Queen Size Mattress | 1 g-1.5 | g |
| King Size | 2 g-3 | g |
| Regular Single | 0.4-6 | g |
| Pillow | 0.1-1.0 | g |

1. A method of eliminating, reducing or preventing unwanted pests present in articles made from fabrics, comprising: (a) placing a fabric article to be decontaminated into a confined container together with at least one salt capable of generating an effective quantity carbon dioxide or ammonia, (b) sealing the confined container to prevent the loss of gas within the container, (c) causing the at least one salt to release carbon dioxide or ammonia gas into the atmosphere of the container, (d) allowing the gas to pervade the container and the fabric article therein for such a time as is needed for the trapped gas to kill any pests, and (e) subsequently causing the trapped gas to escape safely from the fabric article and container into the atmosphere.

2. The method of claim 1, wherein the confined container is a plastic bag.

3. The method of claim 1, wherein the air in the confined container is first partially or completely evacuated to increase the proportion of ammonia or carbon dioxide in the container during decontamination.

4. The method of claim 1, wherein said at least one salt capable of releasing carbon dioxide or ammonia is entrapped within a woven or non-woven sheet of material.

5. The method of claim 1, wherein said fabric article is selected from bedding, mattresses, pillows and cushions.

6. The method of claim 1, wherein said salt is capable of generating both ammonia and carbon dioxide.

7. The method of claim 6, wherein said salt is ammonium bicarbonate, ammonium carbonate, ammonium carbamate.

8. The method of claim 1, wherein said salt is a potassium or sodium bicarbonate.

9. The method of claim 1, wherein said carbon dioxide or ammonia is generated by heating said at least one salt.

10. The method of claim 1, wherein said carbon dioxide is generated by adding water to a carbonate salt.

11. The method of claim 1, wherein carbon dioxide is generated by combining a bicarbonate or carbonate with an acid or acidic salt.

12. The method of claim 7, wherein said ammonia gas is generated by heating said at least one salt.

13. The method of claim 1, wherein carbon dioxide or ammonia gas are generated by enclosing said at least one salt in a sealed pouch having separate compartments, one of said compartments containing water and the other compartment contains an exothermic hydratable salt.

14. The method of claim 1, wherein said ammonia is generated by reacting an ammonium salt with an alkali or alkaline salt.

15. The method of claim 1, wherein said pests include at least one of dust mites, fleas, bed bugs, arachnids or insects.

16. A method of eliminating, reducing or preventing unwanted pests present in fabric articles, comprising placing said fabric article in contact with a woven or non-woven sheet of material, having entrapped therein at least one salt capable of releasing carbon dioxide or ammonia, causing the at least one salt to release carbon dioxide or ammonia gas for contact with said fabric article, allowing the gas to contact the fabric article for such a time as is needed for the gas to kill any pests.

17. The method of claim 16, wherein said at least one salt is capable of generating both ammonia and carbon dioxide.

18. The method of claim 17, wherein said salt is ammonium bicarbonate, ammonium carbonate or ammonium carbamate.

19. The method of claim 17, wherein said gas is generated by heating said woven or non-woven sheet.

20. The method of claim 16, wherein said woven or non-woven sheet includes a lining to separate the at least one salt from contacting human skin.
